(19) United States
(12) Patent Application Publication
(10) Pub. No.: US 2026/0364929 A1
(43) Pub. Date: Nov. 19, 2026

(54) HIGH COF FILM AND PACKAGE

(71) Applicant: AMCOR FLEXIBLES NORTH AMERICA, INC., Neenah, WI (US)

(72) Inventors: Melissa K. COOLICH, Hortonville, WI (US); Ross K. GRUETZMACHER, Neenah, WI (US); Marcelo B. ELIAS, Appleton, WI (US)

(21) Appl. No.: 19/133,664

(22) PCT Filed: Dec. 20, 2022
(86) PCT No.: PCT/US2022/053542

§ 371 Date: May 28, 2025

(51) Int. Cl. B32B 27/32; B32B 7/022; B32B 27/08; B65D 75/26

(52) U.S. Cl. CPC B32B 27/32; B32B 7/022; B32B 27/08; B65D 75/26; B32B 2250/242; B32B 2307/30; B32B 2307/516; B32B 2307/518; B32B 2307/72; B32B 2307/744; B32B 2439/40; B32B 2439/70

(57) ABSTRACT

A high coefficient of friction (COF) film is disclosed. The high COF film includes an oriented film including a first outer layer located at a first outer surface of the high COF film. The first outer layer includes a first high density polyethylene. The first outer surface includes a static COF to itself in a range of from 0.5 to 0.9 according to ASTM D1894. The first high density polyethylene includes a melt index (MI) in a range of from 1.0 to 15.0 g/10 min according to ASTM D1238 (190 °C/2.16 kg). The high COF film further includes a total composition including in a range of from 70% to 100% polyethylene, by weight.

### TECHNICAL FIELD

The present application relates generally to a high coefficient of friction (COF) film and a package including the high COF film.

### BACKGROUND

Many products, such as consumer products, food products, and industrial products are packaged in large format packages. These large format packages are typically formed from packaging films that are laminations including exterior films of biaxially oriented polyethylene terephthalate (BOPET), biaxially oriented polypropylene (BOPP), or biaxially oriented nylon (BON). These exterior films may have very high coefficient of friction (COF) surface characteristics. Such packaging films and packages may be difficult to recycle in the available recycling streams. As a result, such packaging films and packages are typically considered as “waste” after the package is emptied.

Therefore, to simplify recyclability, there is an increasing demand for all-polyethylene films for such packaging applications. The all-polyethylene films typically include high density polyethylene (HDPE) in its exterior layer in order to have the heat resistance required for such packaging applications. However, standard blown HDPE is naturally slippery and has a low coefficient of friction (COF).

Large format packages may be palletized (i.e., stacked on top of one another) during storage and/or transportation. The exterior surface of the large format packages may need to have a high static COF (e.g., static COF >0.5) so as to prevent the stacked packages from sliding off of one another. To increase the COF of the exterior surface, coatings or additives may be added to the exterior layer. However, this adds additional process steps and may negatively impact the recyclability of the all-polyethylene films. Moreover, these solutions may decrease the heat resistance of the all-polyethylene films, thereby causing difficulties in forming the packages from the all-polyethylene films.

### SUMMARY

A high coefficient of friction (COF) polyethylene-based film has been developed. The high COF film may be suitable for forming large format packages (e.g., large format pouches or bags). The packages formed from the high COF film may have an exterior surface having a high static COF. Therefore, the packages formed from the high COF film may be suitable to be palletized (i.e., stacked on top of one another) during storage and/or transportation. Specifically, packages formed from the high COF film may not slide off of one another when palletized. Advantageously, the high COF film may include optical and physical properties that are suitable for large format packaging applications.

Furthermore, the high COF film may be recyclable.

One embodiment of the present disclosure is a high coefficient of friction (COF) film. The high COF film includes an oriented film. The oriented film includes a first outer layer located at a first outer surface of the high COF film. The first outer layer includes a first high density polyethylene. The first outer surface includes a static COF to itself in a range of from 0.5 to 0.9 according to ASTM D1894. The first high density polyethylene includes a melt index (MI) in a range of from 1.0 to 15.0 g/10 min according to ASTM D1238 (190 °C/2.16 kg). The high COF film includes a total composition including in a range of from 70% to 100% polyethylene, by weight.

The high COF film may be suitable for forming large format packages. The large format packages formed from the high COF film may include an exterior surface formed by the first outer surface. As a result, the exterior surface of the large format packages may have a high static COF to itself. When the large format packages are palletized, the exterior surfaces of the large format packages may engage with each other. The high static COF of the exterior surfaces may prevent the large format packages from sliding off of one another.

It has been surprisingly found that a surface of an oriented layer including a high-density polyethylene (HDPE) having a high melt index (e.g., in a range of from 1.0 to 15.0 g/10 min according to ASTM D1238 (190 °C/2.16 kg)) exhibits a high static COF (e.g., in the range of from 0.5 to 0.9) to itself. HDPE polymers including a high MI have shorter polymer chains, which can crystallize faster than longer polymer chains of low MI polymers. Layers that include HDPE including the high MI, when oriented, may have a smoother surface which results in a higher static COF.

Moreover, the static COF of the surface of the oriented layer may be proportional to an orientation level of the oriented layer. The static COF of the surface of the orientation layer may increase as the orientation level of the orientation layer increases.

In some embodiments, the oriented film may include an orientation level of above 5×, above 6×, or above 7×.

In some embodiments, the oriented film is monoaxially oriented in the machine direction.

In some embodiments, the oriented film is biaxially oriented.

The oriented film may be monoaxially oriented or biaxially oriented in-line or out-of-line by any suitable process. Preferably, the oriented film may be oriented in-line.

In some embodiments, the first outer layer is free of antiblock particles. Therefore, the high static COF (specifically, in a range of from 0.5 to 0.9) of the first outer surface may not be compromised due to a presence of the antiblock particles.

In some embodiments, the oriented film further includes a second outer surface opposite to the first outer surface. The second outer surface includes a static COF to itself in a range of from 0.0 to 0.5 according to ASTM D1894.

The static COF of the second outer surface to itself may be less than the static COF of first outer surface to itself. This may be achieved by any suitable method, except by use of a migratory slip agent or other agents that can transfer to the first exterior surface when the high COF film is in a roll format and detrimentally affect the static COF of the first outer surface to itself. The static COF of the second outer surface being lower than the high static COF of the first outer layer may reduce or prevent blocking of the high COF film during unrolling from the roll format.

In some embodiments, the oriented film further includes a second outer layer located at the second outer surface. The second outer layer includes a second high density polyethylene including a melt index (MI) in a range of from 0.2 to 1.0 according to ASTM D1238 (190 °C/2.16 kg).

In some embodiments, the oriented film further includes a second outer layer located at the second outer surface. The second outer layer includes a second high density polyethylene and antiblock particles.

In some embodiments, the oriented film further includes a first inner layer including a medium density polyethylene. The first inner layer may improve toughness, puncture resistance, and durability of the high COF film. The first inner layer may function as a bulk layer.

In some embodiments, the high COF film further includes a 45° gloss in a range of from 60% to 99% according to ASTM D2457.

In some embodiments, the high COF film further includes a haze in a range of from 0% to 15%, from 0% to 10%, or from 0% to 8% according to ASTM D1003.

Therefore, the high COF film may have good optical properties for packaging applications.

In some embodiments, the high COF film further includes a sealing layer connected to the oriented film at the second outer surface. The sealing layer may be connected to the oriented film by any suitable means, such as adhesive lamination and extrusion coating. The sealing layer may be single layered or multilayered.

In some embodiments, the sealing layer is free of a migratory slip agent. Therefore, the sealing layer may not detrimentally affect the static COF of the first outer surface when the high COF film is in the roll format.

In some embodiments, the first outer surface is exposed to the environment. Another embodiment of the present disclosure is a package. The package includes a high coefficient of friction (COF) film. The high COF film includes an oriented film. The oriented film includes a first outer layer. The first outer layer includes a first high density polyethylene. The oriented film further includes a first outer surface and a second outer surface. The high COF film further includes a sealing layer attached to the oriented film at the second outer surface. The high COF film further includes one or more seals attaching the sealing layer to itself to form the package. The first outer surface is exposed to the environment and includes a static COF to itself in a range of from 0.5 to 0.9 according to ASTM D1894. The first high density polyethylene includes a melt index (MI) in a range of from 1.0 to 15.0 g/10 min according to ASTM D1238 (190 °C/2.16 kg). The package includes a total composition including in a range of from 70% to 100% polyethylene, by weight.

The package may be suitable for being palletized with other packages during storage and/or transportation due to the high static COF of the first outer surface. The stacked or palletized packages may not slide off of one another when palletized. Furthermore, the package may be recyclable.

In some embodiments, the size and shape of the package is configured to contain a product that is in a range of from 8 to 60 pounds (3.62874 kilograms to 27.2155 kilograms).

In some embodiments, the configuration of the package is that of a lay down pouch.

In some embodiments, the package further includes a product.

In some embodiments, the product is an industrial product.

In some embodiments, the product is an animal or human food product.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic cross-sectional view of a high coefficient of friction (COF) film in accordance with an embodiment of the present disclosure;

FIG. 2 is a schematic cross-sectional view of a high COF film in accordance with another embodiment of the present disclosure

FIG. 3 is a schematic cross-sectional view of a high COF film in accordance with another embodiment of the present disclosure;

FIG. 4 is a schematic cross-sectional view of a high COF film in accordance with another embodiment of the present disclosure;

FIG. 5 is a schematic perspective view of a package in accordance with an embodiment of the present disclosure;

FIG. 6 is a schematic cross-sectional view of the package taken along a line 1-1 of FIG. 5 in accordance with an embodiment of the present disclosure;

FIG. 7 is a schematic perspective view of a plurality of packages stacked on top of one another in accordance with an embodiment of the present disclosure; and

FIG. 8 is a schematic cross-sectional view of the plurality of packages taken along a line 2-2 of FIG. 7 in accordance with an embodiment of the present disclosure.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

The present application describes a high coefficient of friction (COF) film. The high COF film includes an oriented film. The oriented film includes a first outer layer located at a first outer surface of the high COF film. The first outer layer includes a first high density polyethylene. The first outer surface includes a static COF to itself in a range of from 0.5 to 0.9 according to ASTM D1894. The first high density polyethylene includes a melt index (MI) in a range of from 1.0 to 15.0 g/10 min according to ASTM D1238 (190 °C/2.16 kg). The high COF film includes a total composition including in a range of from 70% to 100% polyethylene, by weight.

The high COF film may be suitable for forming large format packages. The large format packages formed from the high COF film may include an exterior surface formed by the first outer surface. As a result, the exterior surface of the large format packages may have a high static COF to itself. When the large format packages are palletized, the exterior surfaces of the large format packages may engage with each other. The high static COF of the exterior surfaces may prevent the large format packages from sliding off of one another.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, the term “film” is a material with a very high ratio of a length or a width to a thickness. A film has two major surfaces defined by a length and a width. Films typically have good flexibility and can be used for a wide variety of applications. Films may also be of suitable thickness and/or material composition such that they are flexible, semi-rigid, or rigid. Films may be described as monolayer or multilayer.

Unless specified or limited otherwise, the terms “attached,” “connected,” “coupled,” and variations thereof are used broadly and encompass both direct and indirect attachments, connections, and couplings.

As used herein, the term “adjacent” refers to being near, close, contiguous, adjoining, or neighboring in proximity. It includes, but is not limited to, being reasonably close to or in the vicinity of as well as touching, having a common boundary or having direct contact.

As used herein, the term “polymer” or “polymeric” refers to a material which is the product of a polymerization or copolymerization reaction of natural, synthetic, or natural and synthetic monomers and/or comonomers, and is inclusive of homopolymers, copolymers, terpolymers, etc. As used herein, the term “polyethylene polymer,” “polyethylene,” or “PE” refers to, unless indicated otherwise, ethylene homopolymers or copolymers. The term “polyethylene” or “PE” is used without regard to the presence or absence of substituent branch groups. Polyethylene includes, for example, medium density polyethylene, high density polyethylene, low density polyethylene, linear low-density polyethylene, ultra-low density polyethylene, ethylene alpha-olefin copolymer, or blends of such. The polyethylene polymer may be a homopolymer of ethylene or a copolymer of ethylene and other monomers. Examples of polyethylene polymers include but are not limited to low-density polyethylene (LDPE), high-density polyethylene (HDPE), linear low-density polyethylene (LLPDE), metallocene-catalyzed linear-low density polyethylene (mLLDPE), ethylene-vinyl acetate copolymer (EVA), cyclic olefin copolymers (COC), and maleic anhydride grafted polyethylene (MAH-PE). As used herein, “polyethylene” does not encompass ethylene vinyl alcohol copolymers (EVOH), as this material is accounted for separately.

As used herein, the term “polyethylene-based” refers to an article (i.e., a bag, a film, a layer, etc.) that comprises high levels of polyethylene-based polymers. In some cases, a polyethylene-based article has at least 50% polyethylene-based polymers, by weight. Or a polyethylene-based article may have at least 60%, at least 70%, at least 80%, at least 90% or at least 95% polyethylene-based polymers, by weight. In some cases, a polyethylene-based article consists of polyethylene-based polymers.

As used herein, the term “high density polyethylene” or “HDPE” refers to both (a) homopolymers of ethylene which have densities from about 0.960 g/cm³ to about 0.970 g/cm³ and (b) copolymers of ethylene and an alpha-olefin (usually 1-butene or 1-hexene) which have densities from about 0.941 g/cm³ to about 0.970 g/cm³. HDPE includes polymers made with Ziegler or Phillips type catalysts and polymers made with single site metallocene catalysts. HDPE may include one HDPE polymer or a blend of two or more HDPE polymers. For example, two or more HDPE polymers may be blended to achieve a desired melt index.

As used herein, the term “medium-density polyethylene” or “MDPE” refers to homopolymers and copolymers of ethylene having a density from about 0.926 g/cm³ to about 0.940 g/cm³.

As used herein, the term “blown film extrusion” refers to a process in which a polymer melt is extruded through a circular die followed by bubble-like expansion.

As used herein, the term “cast film extrusion” refers to a process in which plastic resins are melted and pushed through a slit die into films or sheets, cooled down, and then wound up. The cast film is then cut as required by saws, shears, hot wire, or other methods.

As used herein, the term “antiblock particles” refers to additives that are added to a film, sheet, or a layer to create surface roughness (i.e., “little bumps”) in order to minimize blocking (i.e., adhesion between two adjacent layers). The asperities may minimize layer-to-layer surface contact between two adjacent layers including the antiblock particles. The asperities may increase the distance between the two adjacent layers, thereby minimizing blocking. Antiblock particles may be organic or inorganic. Examples of inorganic antiblock additives include, but are not limited to, talc, calcium carbonate, ceramic spheres, mica, and the like. Examples of organic antiblock additives include, but are not limited to, bis-amide, primary amide, secondary amide, organic stearate, and the like. Inorganic antiblock particles may be non-migratory additives. Organic antiblock particles may be migratory additives.

As used herein, the term “sealing layer” refers to a layer involved in the sealing of a film to itself or to other films. Sealing layer may be a heat-sealing layer which is heat sealable. That is, a sealing layer may be capable of bonding by conventional indirect heating means which generate sufficient heat on at least one film contact surface for conduction to the contiguous film contact surface and formation of a bond interface therebetween without loss of the layer integrity.

As used herein, the term “static coefficient of friction” or “static COF” refers to a measure of the amount of friction existing between two surfaces at rest. In order for motion to take place, the static coefficient of friction must be overcome. It may be measured according to the procedures of ASTM D1894 at 23 °C.

As used herein, the term “45° gloss” refers to film gloss as viewed from an angle of 45° and then measured. It may be measured according to the procedures of ASTM D2457.

As used herein, the term “haze” refers to the scattering of light as it passes through a film. It may be measured according to the procedures of ASTM D1003.

As used herein, the term “barrier property” refers to a property of a material or layer which controls a permeable element of a film, sheet, web, package, etc., against aggressive agents, and includes, but is not limited to, oxygen barrier, moisture (e.g., water, humidity, etc.) barrier, chemical barrier, and the like. The term “barrier film” refers to films that provide such barrier properties.

As used herein, the term “melt index” or “MI” refers to a measure of flow of a melt of a polymer. Melt index may be measured according to ASTM D1238-13 at 190 °C using 2.16 kg weight.

As used herein, the term “oriented film” refers to a film which has been elongated in at least one of a machine direction and a transverse direction. Orientation may be mono-directional (machine direction or transverse direction), or bi-directional stretching of the film, increasing the machine direction and/or transverse direction dimension and subsequently decreasing the thickness of the material. Bi-directional orientation may be imparted to the film simultaneously or successively. Stretching in either or both directions is subjected to the film in the solid-phase at a temperature just below the melt temperature of the polymers in the film. In this manner, the stretching causes the polymer chains to “orient”, changing the physical properties of the film. At the same time, the stretching thins the film. The resulting films are thinner and can have significant changes in mechanical properties such as toughness, heat resistance, stiffness, tear strength and barrier.

As used herein, the term “orientation level” refers to a degree of orientation of a layer. For example, an oriented film may have an orientation level of 2×, 3×, 4×, 5×, and so forth.

As used herein, “at least one of A and B” should be understood to mean “only A, only B, or both A and B”.

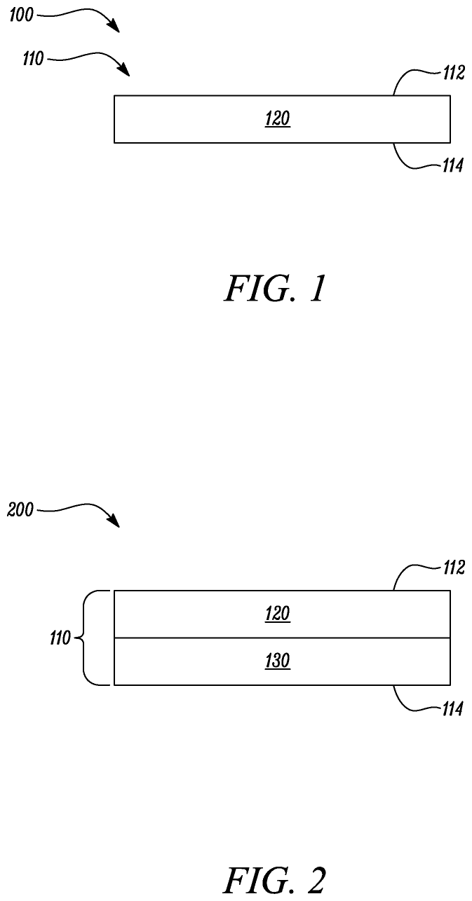

FIG. 1 shows a schematic cross-sectional view of a high coefficient of friction (COF) film 100 in accordance with an embodiment of the present disclosure.

High COF film 100 includes an oriented film 110. Oriented film 110 includes a first outer surface 112 and a second outer surface 114 opposite to first outer surface 112. In some embodiments, first outer surface 112 may be of high COF film 100. In other words, first outer surface 112 of oriented film 110 may form a first outer surface of high COF film 100. First outer surface 112 may be exposed to the environment when the high COF film 100 is used in a packaging application.

Oriented film 110 may be monoaxially oriented or biaxially oriented. Specifically, in some embodiments, oriented film 110 may be monoaxially oriented in the machine direction. In some other embodiments, oriented film 110 may be biaxially oriented. In other words, in some embodiments, oriented film 110 may be oriented in both the machine direction and the transverse direction. Oriented film 110 may be oriented in-line or out-of-line with extrusion, by any suitable process. Preferably, oriented film 110 may be oriented in-line. Oriented film 110 may be manufactured by any suitable process, such as a blown film extrusion process and a cast film extrusion process.

Also, the oriented film may be annealed. After orientation, films have an embedded stress. Upon heating an oriented film, this stress may be released, causing the films to shrink back to their original, pre-orientation, size. This may be problematic when applying heat to the film during the process of heat sealing in a packaging application. Shrinkage of the oriented film at this point will result in a poor appearance in the heat seal area of the package. Additionally, a film that exhibits shrink under heat conditions will be very difficult to apply printed indicia, as this process generally uses high temperatures. The process of annealing can help alleviate the embedded stress caused by orientation and the film will be “heat set” such that it will not shrink back to the original size at lower operating temperatures.

The oriented film may be oriented and annealed in line. The oriented film may be biaxially oriented and annealed in line using known processes, such as the triple bubble process. The base film may be coextruded on a flat die system with machine direction orientation and annealing in-line. The base film may be coextruded on a flat die system and machine direction stretched followed by transverse direction stretched (i.e., tenter frame orientation process) and annealed in-line. Alternatively, the processes of orientation and annealing may be done in separate processes. Annealing is typically accomplished in-line through high diameter rollers set up at temperatures a few degrees lower than the melting point of the polymer or blend of polymers present in the film. However, annealing can be done by any known means including hot air or IR heating.

Oriented film 110 may be a polyethylene-based film. In some embodiments, oriented film 110 may include in a range of from 70% to 100%, or 80% to 100% polyethylene, by weight. In some embodiments, oriented film 110 may include in a range of from 90% to 100% polyethylene, by weight. In some embodiments, oriented film 110 may include in a range of from 95% to 100% polyethylene, by weight.

Oriented film 110 further includes a first outer layer 120. First outer layer 120 is located at first outer surface 112 of high COF film 100. First outer layer 120 may form first outer surface 112. In the illustrated embodiment of FIG. 1, first outer layer 120 further forms second outer surface 114 of oriented film 110. However, in some other embodiments, first outer layer 120 may not form second outer surface 114.

First outer layer 120 includes a first high density polyethylene. The first high density polyethylene includes a melt index (MI) in a range of from 1.0 to 15.0 g/10 min, or from 1.5 to 15.0 g/10 min, or from 1.5 to 8.0 g/10 min, or from 1.5 to 6.0 g/10 min, according to ASTM D1238 (190 °C/2.16 kg). Further, first outer surface 112 includes a static COF to itself in a range of from 0.5 to 0.9 according to ASTM D1894. First outer layer 120 may include in a range of from 90% to 100% of the first high density polyethylene, by weight. In some embodiments, first outer layer 120 may include 100% of the first high density polyethylene, by weight.

It has been surprisingly found that a surface of an oriented layer including a high-density polyethylene (HDPE) having a high melt index (e.g., in a range of from 1.0 to 15.0 g/10 min according to ASTM D1238 (190 °C/2.16 kg)) exhibits a high static COF (e.g., in the range of from 0.5 to 0.9) to itself. HDPE polymers including a high MI have shorter polymer chains, which can crystallize faster than longer polymer chains. Layers that include HDPE including the high MI, when oriented, may have a smoother surface which results in a higher static COF.

Moreover, the static COF of the surface of the oriented layer may be proportional to an orientation level of the oriented layer. The static COF of the surface of the orientation layer may increase as the orientation level of the oriented film increases. Accordingly, in some embodiments, oriented film 110 may preferably include an orientation level of above 5×, above 6×, or above 7×.

First outer layer 120 may be free of antiblock particles. Therefore, the high static COF (specifically, in a range of from 0.5 to 0.9) of first outer surface 112 may not be compromised due to a presence of the antiblock particles. Moreover, first outer layer 120 being free of the antiblock particles may improve the recyclability of high COF film 100. High COF film 100 may be suitable for forming large format packages. The large format packages formed from high COF film 100 may include an exterior surface formed by first outer surface 112. As a result, the exterior surface of the large format packages may have a high static COF to itself. When the large format packages are palletized, the exterior surfaces of the large format packages may engage with each other. The high static COF of the exterior surfaces may prevent the large format packages from sliding off of one another.

The first high density polyethylene including the MI in the range of from 1.0 to 15.0 g/10 min may further impart improved optical properties to high COF film 100. In some embodiments, high COF film 100 may further include a 45° gloss in a range of from 60% to 99% according to ASTM D2457. Furthermore, high COF film 100 may include a haze in a range of from 0% to 10% according to ASTM D1003. Therefore, high COF film 100 may have good optical properties for packaging applications.

High COF film 100 further includes a total composition including in a range of from 70% to 100%, or 80% to 100% polyethylene, by weight. In some embodiments, high COF film 100 may include the total composition including in a range of from 90% to 100% polyethylene, by weight. In some embodiments, high COF film 100 may include the total composition including in a range of from 95% to 100% polyethylene, by weight. High COF film 100 may therefore be recyclable. For example, high COF film 100 may be recyclable in a polyethylene recycling stream.

FIG. 2 shows a schematic cross-sectional view of a high COF film 200 in accordance with another embodiment of the present disclosure. High COF film 200 is similar to high COF film 100 of FIG. 1, with like elements designated by like reference characters.

As shown in FIG. 2, oriented film 110 may further include a second outer layer 130. Second outer layer 130 may include a second high density polyethylene. The second high density polyethylene may be different from the first high density polyethylene of first outer layer 120.

Second outer layer 130 may be located at second outer surface 114. Further, second outer layer 130 may form second outer surface 114 of oriented film 110.

High COF film 200 may be rolled into a roll format. To facilitate unrolling of high COF film 200 from the roll format, it may be important that second outer surface 114 of oriented film 110 has a low static COF. Second outer surface 114 may be made to have a low static COF by any known means (i.e., embossing, permanent slip agent), except by use of a migratory slip agent or other agents that can transfer to first outer surface 112 when high COF film 200 is in the roll format. That is, second outer layer 130 may be free of a migratory slip agent.

Second outer surface 114 may include a static COF to itself in a range of from 0.0 to 0.5 according to ASTM D1894. Therefore, the static COF of second outer surface 114 may be less than the static COF of first outer surface 112.

In some embodiments, the second high density polyethylene may include a melt index (MI) in a range of from 0.2 to 1.0 according to ASTM D1238 (190 °C/2.16 kg). The melt index of the second high density polyethylene may be less than the melt index of the first high density polyethylene of first outer layer 120.

As the melt index of the second high density polyethylene may be less than the melt index of the first high density polyethylene, second outer surface 114 may include a static COF less than that of first outer surface 112.

Alternatively or additionally, antiblock particles may be added to second outer layer 130 to decrease the static COF of second outer surface 114 to itself. Specifically, in some embodiments, second outer layer 130 may further include antiblock particles. The antiblock particles may resist transfer to first outer surface 112 in the roll format of high COF film 200.

FIG. 3 shows a schematic cross-sectional view of a high COF film 300 in accordance with another embodiment of the present disclosure. High COF film 300 is similar to high COF film 200 of FIG. 2, with like elements designated by like reference characters.

As shown in FIG. 3, oriented film 110 may further include a first inner layer 140. First inner layer 140 may be located between first outer layer 120 and second outer layer 130. First inner layer 140 may be selected to impart desired properties (e.g., barrier properties, physical properties, etc.) to high COF film 300.

In some embodiments, first inner layer 140 may be a barrier layer having barrier properties. In such embodiments, first inner layer 140 may provide barrier properties to high COF film 300. First inner layer 140 may include, for example, EVOH or polyamide. However, it may be preferable to minimize non-polyethylene layers for recycling purposes.

In some other embodiments, first inner layer 140 may include a medium density polyethylene. In such embodiments, first inner layer 140 may improve toughness, puncture resistance, and durability of high COF film 300. First inner layer 140 may function as a bulk layer.

In some embodiments of the high coefficient of friction film, the oriented film is combined with one or two other films (i.e., two or three ply). The oriented film may have a barrier layer deposited on the second outer layer, or the oriented film may be laminated to another polyethylene film that has a barrier layer deposited thereon. A deposited barrier layer may be metalization or inorganic coating.

Although not illustrated in FIG. 3, oriented film 110 may include a plurality of first inner layers 140 located between first outer layer 120 and second outer layer 130. Plurality of first inner layers 140 may be different from each other.

As shown in FIG. 3, first outer layer 120 may include a first outer thickness 120T. Second outer layer 130 may include a second outer thickness 130T. First inner layer 140 (or plurality of first inner layers 140 in some embodiments) may include an inner thickness 140T. Moreover, oriented film 110 may include an overall thickness 110T. Overall thickness 110T may be the sum of first outer thickness 120T, second outer thickness 130T, and inner thickness 140T.

First outer thickness 120T may be about 10% to about 20% of overall thickness 110T. Second outer thickness 130T may be about 10% to about 20% of overall thickness 110T. Inner thickness 140T may be about 60% to about 80% of overall thickness 110T.

In some embodiments, first outer thickness 120T may be about 15% of overall thickness 110T, second outer thickness 140T may be about 15% of overall thickness 110T, and inner thickness 140T may be about 70% of overall thickness 110T. Such a configuration of high COF film 300 may provide optimal properties (such as optical properties and physical properties) for packaging applications.

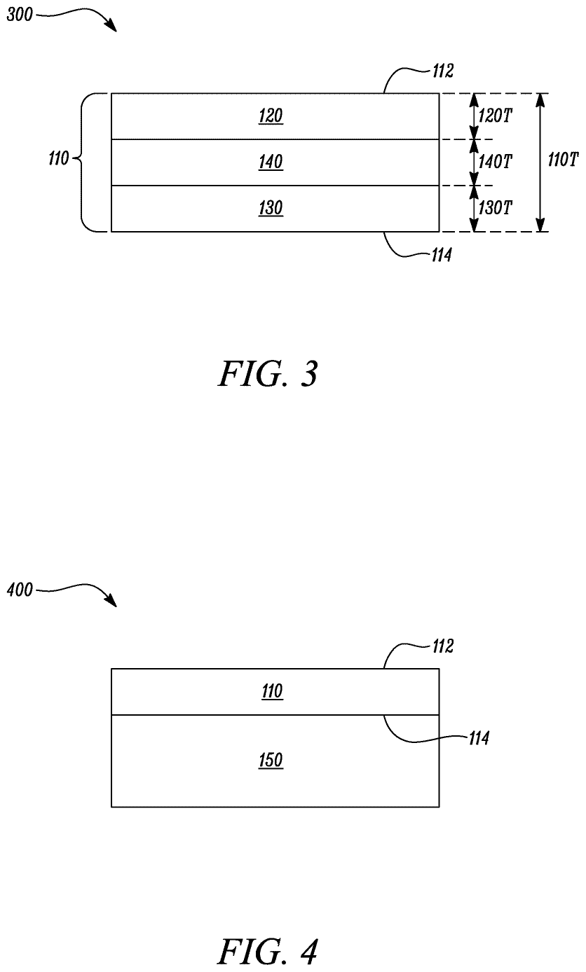

FIG. 4 shows a schematic cross-sectional view of a high COF film 400 in accordance with another embodiment of the present disclosure. High COF film 400 is similar to high COF films 100, 200, 300 of FIGS. 1, 2, and 3, respectively, with like elements designated by like reference characters.

As shown in FIG. 4, high COF film 400 may include a sealing layer 150 connected to oriented film 110 at second outer surface 114. Sealing layer 150 may be connected to oriented film 110 by any suitable means, such as adhesive lamination or extrusion coating. If multilayer, the sealing layer may contain an EVOH containing layer. Sealing layer 150 may be single layered or multilayered. In some embodiments, sealing layer 150 is not oriented.

High COF film 400 may be rolled into the roll format. Therefore, it may be important that sealing layer 150 may not detrimentally affect the static COF of first outer surface 112. Therefore, sealing layer 150 may be free of a migratory slip agent.

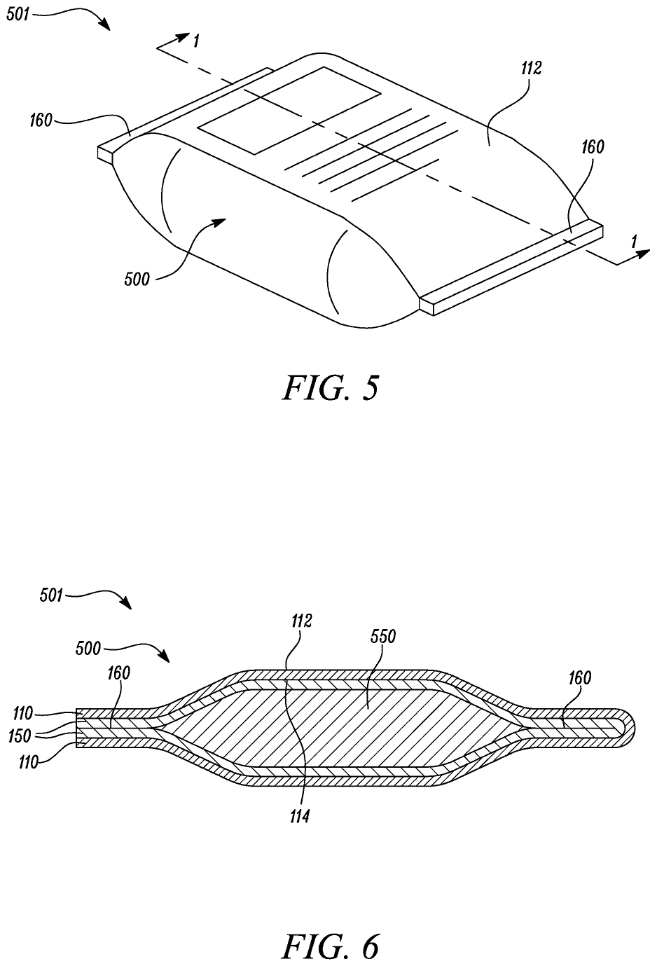

FIG. 5 shows a schematic perspective view of a package 501 in accordance with an embodiment of the present disclosure. FIG. 6 shows a schematic cross-sectional view of package 501 taken along line 1-1 of FIG. 5.

Referring to FIGS. 5 and 6, package 501 includes a high COF film 500. High COF film 500 is similar to high COF film 400 of FIG. 4, with like elements designated by like reference characters.

High COF film 500 includes oriented film 110 and sealing layer 150 connected to oriented film 110 at second outer surface 114. High COF film 500 further includes one or more seals 160 attaching sealing layer 150 to itself to form package 501. In some embodiments, one or more seals 160 may be heat seals.

Further, package 501 includes a total composition including in a range of from 70% to 100%, or 80% to 100% polyethylene, by weight. In some embodiments, package 501 includes the total composition including in a range of from 90% to 100% polyethylene, by weight. In some embodiments, package 501 includes the total composition including in a range of from 95% to 100% polyethylene, by weight. Therefore, package 501 may be recyclable.

Package 501 may further include a product 550. Product 550 may be in a range of from 8 pounds to 60 pounds (3.62874 kilograms to 27.2155 kilograms). In some embodiments, product 550 may be an industrial product. In some embodiments, product 550 may be an animal or human food product. For example, product 550 may include lawn fertilizer, pet food, cat litter, animal feed, bulk powder, and so forth. The size and shape of package 501 may be configured to contain product 550 that is in a range from 8 pounds to 60 pounds. As shown in FIGS. 5 and 6, in some embodiments, the configuration of package 501 may be that of a lay down pouch.

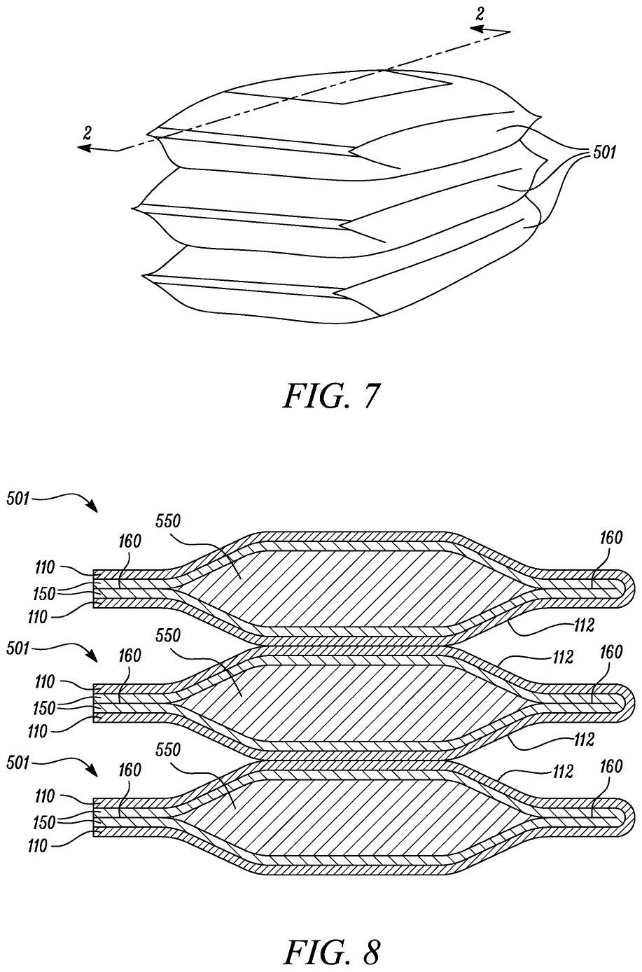

FIG. 7 shows a schematic perspective view of a plurality of packages 501 stacked on top of one another. In other words, plurality of packages 501 is palletized. FIG. 8 shows a schematic cross-sectional view of plurality of packages 501 taken along a line 2-2 of FIG. 7.

Referring to FIGS. 7 and 8, in the stacked configuration, adjacent packages 501 from plurality of packages 501 may engage with each other. Specifically, as shown in FIG. 8, first outer surface 112 of adjacent packages 501 may engage with each other. As first outer surface 112 includes a high static COF (e.g., from 0.5 to 0.9) to itself, plurality of packages 501 may not slide off of one another. Therefore, plurality of packages 501 may be suitable to be palletized and stored and/or transported in the palletized state.

### EXPERIMENTAL RESULTS

Various films were developed with the structure MDPE/HDPE. The MDPE layer of the films remained constant, while the HDPE layer was changed between the films.

The HDPE layer of Comparative Examples 1-3 (CE1-CE3) had a melt index of less than 1. The HDPE layer of Comparative Example 4 (CE4) had a high melt index of 2 with antiblock particles added. The HDPE layer of Example 1 (E1) had a melt index of 2, and the HDPE layer of Example 2 (E2) was a blend of two HDPE polymers and had a melt index of 1.5. Each of the films was oriented in the machine-direction at an orientation level of 5.5×. Other details of the films are tabulated in Table 1 below.

TABLE 1
Details of developed films

| | | | Film-to- | Film-to- | | |
|---|---|---|---|---|---|---|
| | | | Film | Film | | |
| | | | Static | Static | | |
| | | | COF | COF | | |
| | | | (After | (Before | | 45° |
| | | Melt | Orien- | Orien- | Haze | gloss |
| Example | HDPE Layer | Index | tation) | tation) | (%) | (%) |
| CE1 | Exxon | 0.45 | 0.35 | 0.20 | 9.9 | 55.9 |
| | HD7845.30 | | | | | |
| CE2 | Equistar | 0.85 | 0.26 | — | 14 | 46.8 |
| | L5885 | | | | | |
| CE3 | Equistar | 0.85 | 0.41 | — | 9 | 60.4 |
| | L5885 + 2% | | | | | |
| | Nucleant | | | | | |
| CE4 | Equistar | 2 | 0.5 | — | 9.8 | 61.5 |
| | M6020 + 5% | | | | | |
| | Antiblock | | | | | |
| E1 | Equistar | 2 | 0.78 | 0.29 | 7.3 | 62.5 |
| | M6020 | | | | | |
| E2 | 50% Equistar | 1.5 | 0.65 | — | 8.5 | 62.3 |
| | M6020 + | | | | | |
| | 50% Equistar | | | | | |
| | L5885 | | | | | |

As depicted by Table 1, the packaging films of Examples 1 and 2 had a high film-to-film static COF (greater than 0.5). Further, addition of antiblock to the HDPE layer lowered the film-to-film static COF in the case of CE4. Further, when comparing CE2 and CE3, as the surface gloss increased, the film-to-film static COF increased. Table 1 also shows the film-to-film static COF before and after orientation of CE1 and E1. Orientation increased the film-to-film static COF.

Films similar to CE1 and E1 were developed again by blown film extrusion. The films were then oriented at orientation levels of 5× and 7× by in-line machine direction orientation (MDO). The film-to-film static COF was measured at the orientation levels of 5× and 7× at two different locations and is shown in Table 2 below.

TABLE 2
Film-to-Film Static COF at different orientation levels

| | | Film-to-Film | | Film-to-Film | |
|---|---|---|---|---|---|
| Example | HDPE Layer | Static COF (5x) | | Static COF (7x) | |
| CE1 | Exxon HD7845.30 | 0.36 | 0.33 | 0.39 | 0.37 |
| E1 | Equistar M6020 | 0.60 | 0.56 | 1.2 | 0.85 |

As depicted by Table 2, the film-to-film static COF increased with the increase in the orientation level. A layer including HDPE may be oriented at a higher orientation level to attain a higher film-to-film static COF based on desired application attributes.

### EMBODIMENTS

Film Embodiment A: A high coefficient of friction (COF) film comprising:
an oriented film comprising a first outer layer located at a first outer surface of the high COF film, the first outer layer comprising a first high density polyethylene;
wherein the first outer surface comprises a static COF to itself in a range of from 0.5 to 0.9 according to ASTM D1894, wherein the first high density polyethylene comprises a melt index (MI) in a range of from 1.0 to 15.0 g/10 min according to ASTM D1238 (190 °C/2.16 kg); and
wherein the high COF film comprises a total composition comprising in a range of from 70% to 100% polyethylene, by weight.

Film Embodiment B: The high COF film of Film Embodiment A, wherein the oriented film is monoaxially oriented in the machine direction.

Film Embodiment C: The high COF film of Film Embodiment A or B, wherein the oriented film is biaxially oriented.

Film Embodiment D: The high COF film of any previous Film Embodiment, wherein the first outer layer is free of antiblock particles.

Film Embodiment E: The high COF film of any previous Film Embodiment, wherein the oriented film further comprises a second outer surface opposite to the first outer surface, the second outer surface comprising a static coefficient of friction (COF) to itself in a range of from 0.0 to 0.5 according to ASTM D1894.

Film Embodiment F: The high COF film of Film Embodiment E, wherein the oriented film further comprises a second outer layer located at the second outer surface, the second outer layer comprising a second high density polyethylene comprising a melt index (MI) in a range of from 0.2 to 1.0 according to ASTM D1238 (190 °C/2.16 kg).

Film Embodiment G: The high COF film of Film Embodiment E, wherein the oriented film further comprises a second outer layer located at the second outer surface, the second outer layer comprising a second high density polyethylene and antiblock particles.

Film Embodiment H: The high COF film of any previous Film Embodiment, wherein the oriented film further comprises a first inner layer comprising a medium density polyethylene.

Film Embodiment I: The high COF film of any previous Film Embodiment, further comprising a 45° gloss in a range of from 60% to 99% according to ASTM D2457.

Film Embodiment J: The high COF film of any previous Film Embodiment, further comprising a haze in a range of from 0% to 10% according to ASTM D1003.

Film Embodiment K: The high COF film of any previous Film Embodiment, further comprising a sealing layer connected to the oriented film at the second outer surface.

Film Embodiment L: The high COF film of Film Embodiment K, wherein the sealing layer is free of a migratory slip agent.

Film Embodiment M: The high COF film of any previous Film Embodiment, wherein the first outer surface is exposed to the environment.

Package Embodiment A: A package comprising:
a high coefficient of friction (COF) film comprising:
an oriented film comprising a first outer layer comprising a first high density polyethylene, the oriented film comprising a first outer surface and a second outer surface;
a sealing layer attached to the oriented film at the second outer surface; and
one or more seals attaching the sealing layer to itself to form the package;
wherein the first outer surface is exposed to the environment and comprises a static COF to itself in a range of from 0.5 to 0.9 according to ASTM D1894;
wherein the first high density polyethylene comprises a melt index (MI) in a range of from 1.0 to 15.0 g/10 min according to ASTM D1238 (190 °C/2.16 kg); and
wherein the package comprises a total composition comprising in a range of from 70% to 100% polyethylene, by weight.

Packaging Embodiment B: The package of Package Embodiment A, wherein the size and shape of the package is configured to contain a product that is in a range of from 8 to 60 pounds.

Package Embodiment C: The package of Package Embodiment A or B, wherein the configuration of the package is that of a lay down pouch.

Package Embodiment D: The package of any previous Package Embodiment, further comprising a product.

Package Embodiment E: The package of Package Embodiment D, wherein the product is an industrial product.

Package Embodiment F: The package of Package Embodiment D, wherein the product is an animal or human food product.

What is claimed is:

1. A high coefficient of friction (COF) film comprising:
an oriented film comprising a first outer layer located at a first outer surface of the high COF film, the first outer layer comprising a first high density polyethylene;
wherein the first outer surface comprises a static COF to itself in a range of from 0.5 to 0.9 according to ASTM D1894, wherein the first high density polyethylene comprises a melt index (MI) in a range of from 1.0 to 15.0 g/10 min according to ASTM D1238 (190 °C/2.16 kg); and
wherein the high COF film comprises a total composition comprising in a range of from 70% to 100% polyethylene, by weight.

2. The high COF film of claim 1, wherein the oriented film is monoaxially oriented in the machine direction.

3. The high COF film of claim 1, wherein the oriented film is biaxially oriented.

4. The high COF film of claim 1, wherein the first outer layer is free of antiblock particles.

5. The high COF film of claim 1, wherein the oriented film further comprises a second outer surface opposite to the first outer surface, the second outer surface comprising a static coefficient of friction (COF) to itself in a range of from 0.0 to 0.5 according to ASTM D1894.

6. The high COF film of claim 5, wherein the oriented film further comprises a second outer layer located at the second outer surface, the second outer layer comprising a second high density polyethylene comprising a melt index (MI) in a range of from 0.2 to 1.0 according to ASTM D1238 (190 °C/2.16 kg).

7. The high COF film of claim 5, wherein the oriented film further comprises a second outer layer located at the second outer surface, the second outer layer comprising a second high density polyethylene and antiblock particles.

8. The high COF film of claim 1, wherein the oriented film further comprises a first inner layer comprising a medium density polyethylene.

9. The high COF film of claim 1, further comprising a 45° gloss in a range of from 60% to 99% according to ASTM D2457.

10. The high COF film of claim 1, further comprising a haze in a range of from 0% to 10% according to ASTM D1003.

11. The high COF film of claim 1, further comprising a sealing layer connected to the oriented film at the second outer surface.

12. The high COF film of claim 11, wherein the sealing layer is free of a migratory slip agent.

13. The high COF film of claim 1, wherein the first outer surface is exposed to the environment.

14. A package comprising:
a high coefficient of friction (COF) film comprising:
an oriented film comprising a first outer layer comprising a first high density polyethylene, the oriented film comprising a first outer surface and a second outer surface;
a sealing layer attached to the oriented film at the second outer surface; and
one or more seals attaching the sealing layer to itself to form the package;
wherein the first outer surface is exposed to the environment and comprises a static COF to itself in a range of from 0.5 to 0.9 according to ASTM D1894;
wherein the first high density polyethylene comprises a melt index (MI) in a range of from 1.0 to 15.0 g/10 min according to ASTM D1238 (190 °C/2.16 kg); and
wherein the package comprises a total composition comprising in a range of from 70% to 100% polyethylene, by weight.

15. The package of claim 14, wherein the size and shape of the package is configured to contain a product that is in a range of from 8 to 60 pounds.

16. The package of claim 14, wherein the configuration of the package is that of a lay down pouch.

17. The package of claim 14, further comprising a product.

18. The package of claim 17, wherein the product is an industrial product.

19. The package of claim 17, wherein the product is an animal or human food product.
